(19) United States
(12) Patent Application Publication
(10) Pub. No.: US 2023/0279309 A1
(43) Pub. Date: Sep. 7, 2023

(54) Method of Industrially Obtaining Cold-Pressed Core Oil and Protein Concentrate from Hulled Oil-Containing Seeds Using a Seed-Intrinsic Pressing Aid

(71) Applicant: Euro-Protein GmbH, Friedland (DE)

(72) Inventor: Waldemar Neumüller, Friedland-Ballenhausen (DE)

(21) Appl. No.: 18/114,315

(22) Filed: Feb. 27, 2023

Related U.S. Application Data
(63) Continuation of application No. PCT/EP2021/073243, filed on Aug. 23, 2021.

(30) Foreign Application Priority Data
Aug. 27, 2020 (DE) 10 2020 122 456.7

(51) Int. Cl. C11B 1/06; A23J 1/14; A23D 9/02; C11B 1/10

(52) U.S. Cl. CPC C11B 1/06; A23J 1/142; A23D 9/02; C11B 1/10

(57) ABSTRACT

In a method of obtaining cold-pressed core oil at an industrial scale, grains of an oil-containing seed are hulled, and hulls are separated from a low-hull grain fraction of the oil-containing seed. The cold-pressed core oil is pressed from the low-hull grain fraction. A cake temperature in a press cake being generated in pressing is limited to 70° C. A part of the press cake is temporarily heated up to above 100° C. Pressurized steam is supplied to the part of the press cake and the part of the press cake and the pressurized steam are expanded to form collets. Alternatively, the press cake is compressed to form pellets. The collets or pellets are mixed with the low-hull grain fraction prior to the pressing. The collets or pellets are cooled down to a temperature below 60° C.; and the cooled collets or pellets mixed with the low-hull grain fraction are pressed once again.

### CROSS REFERENCE TO RELATED APPLICATIONS

This application is a continuation of International Application PCT/EP2021/073243 with an international filing date of Aug. 23, 2021 and claiming priority to German Patent Application No. DE 10 2020 122 456.7 entitled “Verfahren zur industriellen Gewinnung von kaltgepresstem Kernol and Proteinkonzentrat aus geschalten ölhaltigen Saaten unter Einsatz einer Saat-eigenen Presshilfe”, filed on Aug. 27, 2020.

### FIELD OF THE INVENTION

The present invention generally relates to a method of industrially obtaining cold-pressed kernel oil or core oil, the term “core oil” being a synonym for the term “kernel oil” in this specification and the accompanying claims and drawings.

More particular, the present invention relates to a method of industrially obtaining cold-pressed core oil comprising the steps of: hulling grains of an oil-containing seed and separating the hulls from a low hull grain fraction, and pressing the cold-pressed core oil from the low hull grain fraction, wherein a cake temperature in a press cake being generated is limited to 70° C., and wherein a part of the press cake is returned, mixed with the low-hull grain fraction prior to the pressing and pressed once again. The remaining press cake may be extracted using a solvent and dried to a protein concentrate.

The oil-containing seed may particularly be an oilseed like rape, soybean, sun flower, hemp, linseed and lupin as well as other oil-containing seeds inclusive of but not limited to peanut, almond, sesame and poppy seed.

Following to soybean, rape (Brassica napus), inclusive of so called 0 rape, 00 rape and 00+ rape varieties and canola, is the commercially most important oilseed worldwide. Large amounts of vegetable oil are also obtained from cotton, peanut and linseed. These oil-containing seeds are quantitatively important and valuable raw materials for the food stuff industry, the feeding stuff industry, the biodiesel production and the oleo chemistry. In contrast to soybean which primarily serves as a supplier of vegetable protein, rape and sunflower are, at present, primarily grown for obtaining oil. Hemp, poppy seed, almond, pumpkin and other oil-containing seeds are increasingly demanded in small amounts as specialties in the food sector.

### BACKGROUND OF THE INVENTION

At a large scale, oil from oil-containing seeds is obtained in a mechanical or a chemical way. In obtaining mechanically, the oil is, hot or cold, pressed from the grains of the oil-containing seeds.

According to the general opinion, so-called cold-pressed core oil accrues, if temperatures below 50° C. are kept in pressing. However, the Codex Alimentarius defines cold-pressed oil in that no heat is added in pressing.

According to the Leitsätze für Speisefette und Speiseöle, Deutsches Lebensmittelbuch, Bundesministerium für Ernahrung und Landwirtschaft BMEL, trans-fatty acids of not more than 0.2% are required for cold-pressed oil. Values of more than 0.2 trans-fatty acids are indicative of heat damages.

If the grains of the oil-containing seeds are hulled prior to pressing to obtain a hull-free press cake, the residual oil content of the press cake, with cold-pressing only, due to the lack of friction caused by the hulls, is significantly higher than in press cakes with hulls, and in case of rape seed it is above 15% by weight. Thus, the first cold-pressing is often followed by a second pressing at an increased temperature to increase the yield of oil.

At a large scale, hull-containing press cakes are subsequently extracted with hexane, wherein the residual oil content is reduced down to below 1% by weight, and wherein a coarse meal remains which in case of rape, for example, is only of limited value for food stuff.

In many cases, press cakes remaining from pressing cold-pressed oils in smaller, decentral oil mills are not subsequently extracted with solvents, because this would not be economic for smaller oil mills due to the necessary investment costs and safety requirements.

In order to make the oils from a hot-pressing or the hexane extraction suitable for food stuff, a refining process has to follow.

A method of producing a protein preparation from rape seeds including hulling of the grains of the rape seed, a mechanical de-oiling in which only a part of the oil is separated and which is carried out at a temperature of below 80° C. averaged over the period of the pressing step, and an extraction is known from International Application publication WO 2010/096943 A2 and U.S. Pat. No. 9,351,514 belonging to the same patent family. In the extraction, protein foreign matters are depleted from the protein meal. Subsequently to the extraction, a classification with regard to the grain size takes place to obtain a bulk material of a predetermined grain size distribution. In practice, the known method starts with hulling the grains of the rape seed by dissociation in an impact mill and separation into a high-core coarse fraction and a high-hull fine fraction in an air stream of a zigzag separator. Then, the core fraction is cold-pressed in a screw press at temperatures between 30 and 45° C. down to a residual oil content of about 23 percent by weight, wherein the press cake is obtained in form of compressed strings called press cake pellets. The press cake pellets are then de-oiled with hexane in a Soxhlet apparatus down to a residual oil content below 3%. Then, the solvent is removed in an air stream at room temperature. The extracted protein meal pellets obtained in this way are, without further comminution, treated with an ethanol solution in a percolation process. The ready protein concentrate accruing therefrom is used with or without subsequent comminution.

WO 2010/096943 A2 and U.S. Pat. No. 9,351,514 assume that the rape seed is already dried during storage at temperatures below 95° C., preferably below 40° C., wherein an enzyme deactivation and a limited protein denaturation are the goal to be achieved. However, temperatures below 40° C. do neither cause an enzyme deactivation nor a protein denaturation. Afterwards the grains of the rape seed are divided into a core fraction and a hull fraction in a mill, wherein the hulls are opened by bursting but not by purposefully breaking them.

In the mechanical de-oiling, which is carried out at a temperature below 80° C. averaged over the period of the pressing process, a limit temperature of 40° C., which, according to the common opinion, has to be kept for a good cold-pressed rape core oil (http://en.foodlexicon.org/r0000680.php), is exceeded in the rape core oil.

Besides its direct use, the press cake can be pressed into pellets at the output of the screw press. Soft oilseeds, like for example hulled rape seed, can only be pressed slowly and at a low power due to the missing friction of the press cake being generated. If the output of a screw press is partially closed by a pellet die-plate, the inner pressure and the resistance in the screw press are increased so that the squeezed soft oilseeds can be hardly conveyed by the press screw of the screw press. Thus, parts of the oilseeds pass through the seed box of the screw press and contaminate the oil.

Further, as descripted in WO 2010/096943 A2 and U.S. Pat. No. 9,351,514 themselves, already in pressing the press cake into pellets of a residual oil content below 17 discolorations become apparent, what indicates an considerable protein denaturation. If, according to WO 2010/096943 A2 and U.S. Pat. No. 9,351,514, the press cake nevertheless comprises a residual oil content of as little as at least 10%, a monumental protein denaturation has to be assumed.

In order to achieve a purity of the hulled cores of below 5% or 1% as requested by WO 2010/096943 A2 and U.S. Pat. No. 9,351,514, a considerable loss of cores has to be expected in air separating, because lightweight cores and hull accumulations of the same weight are discharged together. The core parts discharged together with the hulls are no longer available for the overall process and deteriorate the efficiency of the known method. A large-scale application of the known method has not yet taken place.

A method and an arrangement for obtaining oil from leguminous seeds and oilseeds in which the grains, for example of rape seed, are processed by preparing platelets, to which a moistening of these platelets with subsequent expansion at 105 to 125° C. with subsequent cooling below 100° C. and drying as well as pressing at temperatures <100° C. to a residual oil content of 15 to 25% follow, are known from German patent application publication DE 40 35 349 A1. A press cake being generated in pressing is extracted at temperatures of about 65° C.

This known method starts from non-hulled leguminous seeds and oilseeds. These seeds are subjected to an expander treatment at temperatures of 105 to 125° C. without previous cold-pressing. Only after cooling down the expanded material to 65° C., the oil is pressed of. Thus, the expander has the function of a cell disruption by means of cooking to ease pressing-of the oil.

It is a disadvantage that the production of high value cold-pressed core oils from low-hull leguminous seeds and oilseeds is not possible in this way. Further, with the temperatures applied, a protein denaturation occurs which complicates a further purification and production of proteins.

A method and an apparatus for thermally conditioning oilseeds and oleiferous fruits, particularly leguminous seeds, for the production of oils and fats, on the one hand, and of an oil-free or fat-free coarse meal suitable as concentrated feed, on the other hand, are known from German patent DE 35 29 229 C1 and U.S. Pat. No. 4,794,011 belonging to the same patent family. Here, the cleaned, dried and comminuted oilseeds and oleiferous fruits, subsequent to a previous flat-rolling, are, for a short time, heated up to temperatures above 105 up to 148° C. at an over-atmospheric pressure and in an air-free and oxygen-free atmosphere, and afterwards abruptly de-pressurized with simultaneous cooling down to temperatures below 100° C. In this way, it is achieved that the urease activity in the coarse meal is inhibited to a far extent, and that the proteins as a whole as well as their water solubility are conserved to a considerable extent. The known thermal conditioning may take place subsequent to a pressing and prior to an extraction in which an extraction temperature of 50 to 65° C. is adjusted. With regard to rape seed, it is particularly proposed to at first condition the flat-rolled grains under comparatively mild conditions, to then press the warm material for obtaining rape core oil, and to once again thermally condition the press cake at increased conditions, to cool it down, and to extract it in a known way at the end. In this way, it shall be possible to optimally obtain the oil content of the hulls and to achieve a clear separation of pressed rape core oil from the cores and extracted oil from the hulls.

In this known method, only non-hulled oilseeds are used. The expander substitutes a cooking process prior to the extraction. High value cold-pressed core oils are not obtained. With rape, the high temperatures result in protein denaturation.

European Patent EP2 783 576B1 describes a method of producing rape protein concentrate by processing grains of a rape seed. The grains are hulled to obtain a rape core fraction. The rape core fraction is partially de-oiled in a screw press. 5 to 60% of a press cake being generated here are returned and mixed with the rape core fraction upstream of the screw press to increase the friction and the pressure in the screw press. The remainder of the protein containing press cake is washed with an aqueous alcohol solution to at least partially remove sugars, tanning agents, sinapines and glucosinolates, and to produce a rape cake protein concentrate having a residual oil content of 5 to 25% (w/w). The rape cake protein concentrate is dried at temperatures in a range from 60 to 120° C. until its water content is lower than 10%. The rape core fraction may upfront be heated up to 70° C.

It cannot be taken from European Patent EP 2 783 576 B1 at which particles size the returned part of the press cake is added to the rape core fraction and whether the performance of the screw press is increased in this way.

The percentage of the hulls in pressing oil from non-hulled rape is about 15%. When pressing in a screw press, the friction which is necessary to build up a high pressure and to, thus, achieve a high pressing performance is build up by means of the hulls. As European Patent EP 2 783 576 indicates a hull percentage of the rape core fraction of 1 to 10 it may be assumed from the amount of the returned press cake that the increase of the friction by means of the returned press cake is not very effective. The best practical return ratio is indicated with 1:0.25, wherein the press cake, prior to the pressing, is heated up to 70° C. Here, 250 kilogram press cake are added to 1 tonne of rape core fraction, which, in the material to be pressed, then corresponds to about 20% press cake in addition to the 1 to 10% hulls. In other words, 20% press cake compensate for a loss of about 5 to 10% hulls which occurs in hulling the grains.

It has to be regarded as a disadvantage that there is a considerable danger of a germ infestation of the screw press due to the press cake being returned again and again. The temperature of the press cake remains so low that no pasteurization of the press cake takes place. A germ infestation of the screw press results in a toxin load to the press cake and to a carryover of the germs and toxins into all products of the known method.

Even if the germ infestation of the press cake is afterwards annulled by the alcohol-water-extraction, the danger of a toxin load remains. To get rid of the germ infestation and the toxin load, the screw press has to be cleaned and to be disinfected often, which each time means a downtime of the production. Thus, the industrial applicability of the know method is limited.

Additionally, the protein content of the rape cake protein concentrate does not fulfill the definition of a protein concentrate as deduced from soy protein concentrate which requires a protein content related to the dry matter of above 60%. Due to the lower protein content of the rape cake protein concentrate it is a rape protein meal only.

A method and apparatus for obtaining rape core oil and rape protein concentrate from rape seed at an industrial scale are described in International Application PCT/EP2019/058957 of the inventor of the present application which has been published as International Application publication WO 2020/207 565 A1 after the priority date of the present application and which corresponds to U.S. patent application Ser. No. 17/497,214 published as US 2022/0081642 A1. In this known method, grains of a rape seed are hulled. Cold-pressed rape core oil is pressed from a low-hull core fraction with 4 percent by weight hulls at maximum and a water content of 4 to 7 percent by weight. A cake temperature is limited to 70° C. in a press cake being generated, and a first residual oil content is reduced to 18 to 28 percent by weight of the dry matter. Pressurized steam is supplied, and the press cake is subsequently expanded to form collets. In doing so, the steam is metered such that the press cake is temporarily heated up to above 100° C., and that the collets have a temperature of 80° C. to 95° C. after the expansion. The collets are extracted with an organic solvent, wherein a second residual oil content is reduced to 2 percent by weight or less of the dry matter. After the expansion, a part of the collets is returned and mixed with the low-hull core fraction prior to the pressing in order to increase the friction when pressing once again.

German patent application publication DE 10 2009 022 279 A1 and US patent application publication US 2009/0317512 A1 belonging to the same patent family describe the production of vegetable protein concentrates from oleiferous vegetable material, wherein the cells are at first opened by rolling. In this way, flakes of a thickness of 0.28 mm-0.32 mm are obtained which are afterwards defatted in a first extractor in a nonpolar solvent, for example hexane, in a counter-current. In a subsequent second extractor, the hexane-wet material is further extracted with aqueous ethanol of at least 80 percent by weight. Then, a replacement with azeotropic ethanol follows in a third extractor. In a fourth extractor, further ingredients like sugars are dissolved with an alcohol of 60-70 percent by weight. After this ethanol cascade, the material (pomace) is pressed to reduce the solvent. Then, the material is dried over 2 hours at 85° C., and it may be milled afterwards.

It is a disadvantage of this method that three different miscella flows accrue, a) the hexane-flow, b) the mixed flow of hexane-ethanol-water, and c) the aqueous ethanol flow, which deteriorate the recovery of the solvents and increase the costs. As compared to a classic hexane extraction with intermediate drying, followed by an extraction of the sugars by means of aqueous alcohol of 60-70%, this method not only becomes more complicated and more expensive, but also the overall control of the recovery of the solvents and the different extractors becomes more complex without resulting in a better concentrate.

Additionally, core temperatures of above 60° C. are employed over a longer period (120 min at 85° C.) for drying the proteins. It is known that there is a considerable protein denaturation by aqueous alcohol at this temperature.

There still is a need of a universal, stable, reproducible and continuous method by which high value cold-pressed core oil at a high yield and a little denatured protein, particularly as a protein concentrate, are obtained from an oil-containing seed, wherein an implementation of the method at a large scale is ensured.

### SUMMARY OF THE INVENTION

The present invention relates to a method of obtaining cold-pressed core oil at an industrial scale. The method comprises hulling grains of an oil-containing seed other than rape seed and separating hulls from a low-hull grain fraction of the oil-containing seed, and pressing the cold-pressed core oil from the low-hull grain fraction, wherein a cake temperature in a press cake being generated in pressing is limited to 70° C. The method further comprises temporarily heating up a part of the press cake to above 100° C., supplying pressurized steam to the part of the press cake, expanding the part of the press cake and the pressurized steam to form collets, returning and mixing the collets with the low-hull grain fraction prior to the pressing, cooling the collets down to a temperature below 60° C., and pressing the cooled collets mixed with the low-hull grain fraction once again.

The present invention also relates to a method of obtaining cold-pressed core oil at an industrial scale, the method comprising hulling grains of a rape seed and separating hulls from a low-hull grain fraction of the rape seed, and pressing the cold-pressed core oil from the low-hull grain fraction, wherein a cake temperature in a press cake being generated in pressing is limited to 70° C. This method also further comprises temporarily heating up a part of the press cake to above 100° C., supplying pressurized steam to the part of the press cake, expanding the part of the press cake and the pressurized steam to form collets, returning and mixing the collets with the low-hull grain fraction prior to the pressing, cooling the collets down to a temperature below 60° C., and pressing the cooled collets mixed with the low-hull grain fraction once again. In case of this method, the low-hull grain fraction comprises at least one of more than 4% by weight hulls and a water content of less than 4% by weight or of more than 7% by weight. Alternatively or additionally, a residual oil content of the press cake is reduced to less than 18% by weight of a dry matter of the press cake.

The present invention also relates to a method of obtaining cold-pressed core oil at an industrial scale. This method also comprises hulling grains of an oil-containing seed and separating hulls from a low-hull grain fraction of the oil-containing seed, and pressing the cold-pressed core oil from the low-hull grain fraction, wherein a cake temperature in a press cake being generated in pressing is limited to 70° C. This method further comprises temporarily heating up a part of the press cake to above 100° C., compressing the part of the press cake to form pellets, returning and mixing the pellets with the low-hull grain fraction prior to the pressing, cooling the pellets down to a temperature below 60° C., and pressing the cooled pellets mixed with the low-hull grain fraction once again.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a block diagram of a workflow of a method according to the present disclosure and of an apparatus for carrying out the method.

FIG. 2 shows a preferred embodiment of a screw press of the apparatus according to the present disclosure;

FIG. 3 is a block diagram of a workflow of another method according to the present disclosure.

### DETAILED DESCRIPTION

In the method according to the present disclosure of obtaining cold-pressed core oil at an industrial scale, comprising the steps of hulling grains of an oil-containing seed and separating hulls from a low-hull grain fraction, and pressing the cold-pressed core oil from the low-hull grain fraction, wherein a cake temperature in a press cake being generated is limited to 70° C., and wherein a part of the press cake is returned, mixed with the low-hull grain fraction prior to the pressing and pressed once again, the part of press cake, prior to being returned, is compressed to form pellets which are dimensionally stable when being pressed once again, wherein the part of the press cake, prior to being returned, is temporally heated up to above 100° C. and, prior to being pressed again, cooled down again to a temperature below 60° C. Alternatively, the returned part of the press cake is not compressed to form pellets but, after supplying pressurized steam, expanded to from collets, wherein, however, the returned part of the press cake is also temporally heated up to above 100° C., prior to being returned, and cooled down to a temperature below 60° C., prior to being pressed once again. Only in this alternative with the steps of supplying pressurized steam and of expanding to form collets, it applies, if the oil-containing seed is rape seed, that at least one of the following features is present: the low-hull grain fraction comprises more than 4 percent by weight hulls, the low-hull grain fraction comprises a water content of less than 4 percent by weight or more than 7 percent by weight, and a residual oil content of the press cake is reduced to less than 18 percent by weight of a dry matter of the press cake. In the alternative with the steps of supplying pressurized steam and of expanding to form collets, the oil-containing seed may thus also be rape seed, particularly if the residual oil content of the press cake is reduced below 18 percent by weight or preferably below 16 percent by weight of the dry matter of the press cake. Independently on the residual oil content of the press cake and the hull percentage and the water content of the low hull grain fraction, the oil-containing seed, in the alternative with the supplying of pressurized steam and the expanding to form collets, may be any other oilseed than rape seed, in particularly soy, hemp, sunflower, linseed, cotton, peanut, poppy, almond and pumpkin.

In the method according to the present disclosure, the grains of the oil-containing seed are hulled prior to pressing-out the cold-pressed core oil. Correspondingly, the press cake obtained from the pressing, only contains few hulls. Besides a certain increase of quality of the cold-pressed core oil, this particularly results in a considerable increase of the value of the press cake. Vice versa, pressing the low-hull grain fraction down to a low residual oil content while keeping the maximum cake temperature in the press cake being generated of 70° C. proves to be complicated.

Common screw presses for pressing oil are designed for performance, i.e. an as high as possible throughput with a high level of de-oiling shall be achieved. Due to the hulling of the grains and the corresponding lack of hulls in the screw press, there is a decrease in performance which reduces the throughput of a low-hull cold oil pressing as compared to a normal oil cold pressing and incurs further costs, because a larger screw press with a higher power input is needed. Further, there also is a stronger and faster heating of the material in the screw press due to the higher power input.

In the method according to the present disclosure, a part of the press cake is added to the low-hull grain fraction prior to the pressing to increase the friction in the pressing in order to increase the performance of the low-hull cold oil pressing using a screw press and thus the economic efficiency. In the method according to the present disclosure, this returning is not associated with the danger of an infestation of the screw press, as the returned part of the press cake is free of germs and thus hygienically unproblematic because of its thermal treatment. In the method according to the present disclosure, no press cake is added to the low-hull grain fraction prior to the pressing, but pellets or collets with mechanical properties that are varied as compared to the press cake are formed of the returned part of the press cake prior to being added. By means of adding the pellets or collets for increasing the friction in cold pressing, at least the performance data of a usual cold oil pressing of non-hulled oil seeds are achieved, because the mechanical properties of both the pellets and the collets are more suitable for increasing the performance than those of the press cake directly obtained from the pressing.

In that, in the method according to the present disclosure, the friction of the low-hull grain fraction is increased in pressing by returning the collets or pellets, the limitation of the cake temperature in the press cake being generated to 70° C. is at least considerably eased despite pressing out a large portion of the oil contained in the respective oil-containing oil seed. The returning of the collets or pellets may even be necessary to be at all able to limit the cake temperature in the press cake generated to 70° C. despite pressing out an essential portion of the oil contained in the respective oil-containing seed so that, for example, a residual oil content of the press cake of below 18 percent by weight or below 16 percent by weight is achieved.

Surprisingly, it becomes apparent that the returned part of the press cake, both when it is expanded to form the collets of comparatively low density and when it is compressed to form the dimensionally stable pellets of high density, can take over the function of hulls in pressing cold-pressed core oil from hulled oil containing seeds. The collets or pellets have a particularly advantageous effect with an average size adapted to the respective oil-containing seed. Different oil-containing seeds have different average grain sizes so that advantageous minimum and maximum sizes of the collets or pellets depend on the respective oilseed. An advantageous averaged size of the collets or pellets shows an about constant ratio to at least one of an average particle size of the low-hull grain fraction in cold pressing and an average size of the grains of the oil-containing seed.

In the following, reference is made to weight-averaged average sizes which results from calculating the average by weighting the individual particle or grain sizes with the weight of the respective particle or grain in order to avoid that fines whose percentage of the respective total weight, despite their high absolute number, is only small have a too high influence on the average size.

The weight-averaged average size of the collets is preferably at least as big as the average particle size of the low-hull grain fraction. With pellets, the average size is preferably at least half as big as the average particle size of the low-hull grain fraction. An upper limit for the average size of the collets is about 400% with average particle sizes of the low-hull grain fraction up to 5 mm and about 300% with bigger particle sizes. With pellets, the upper limit for the average size is about 300% with average particle sizes of the low-hull grain fraction of up to 5 mm and about 200% with bigger particle sizes. Depending on the geometry of the pellets or collets, some undershooting of the minimum size and or overshooting of the upper limit are possible. However, the upper limits mentioned should not be overshot considerably, as otherwise bridges between the collets and pellets are formed and, as a result, relevant parts of the low-hull grain fraction are compressed to a too small extent. The result would be an increased residual oil content in the press cake.

The desired average size of the collets or pellets can be achieved by controlled crushing and optional subsequent sieving of the crushed material. In practice, the collets or pellets produced at first may be crushed in a defined way by means of crushing rollers.

Collets are even better suited as pressing aids for hulled-containing seeds than pellets, because pellets are already compressed and thus only have a little drainage effect for the oil. In contrast, collets have pores, a large percentage of which remains existent under compression. This increases the drainage of the core oil in oil pressing. At the same time, the collets, similar to hulls, result in discontinuities in the compressed press cake, what additionally eases the oil drainage. These discontinuities are visible in the press cake being generated in the method according to the present disclosure. At temperatures about 25° C., collets are strong and hard. The hardness varies depending on the residual oil content. A residual oil content of 12 to 25 related to dry matter has been proven as being advantageous.

The oil performance of the cold pressing of a hulled oil-containing seed considerable increases due to the pressing aid and reaches the level of cold pressing with hulls. The oil drainage and thus the drainage velocity of the oil at the strainer varies with the amount of crushed collets and makes for a maximum value. Once this maximum value is reached, the oil performance of the press does not change further. This maximum value may be up to 30% above the performance of a cold oil pressing with hulls, because the same amount of haze is generated later at a higher pressure than known from cold oil pressing with hulls.

For producing the collets, the press cake is treated in an expander-extruder under pressure and with steam such that a protein solubility in the collets still is at least 10%, ideally between 60 and 100% of the original protein solubility. For a short term, temperatures up to 140° C. occur at a pressure of 20-40 bar. It is important that these collets are sufficiently sanitized in the expander before the cooled down collets are crushed on the crushing roller. Ideally, the total germ number of the collets is determined. The sanitization is sufficient, if salmonellae can no longer be detected.

Ideally, the protein solubility of the original material (oil-containing seeds) is conserved; however, even collets which are not returned to the pressing may be used, in which the protein solubility is at least 10% of that of the original oil-containing seeds, measured as the NSI-value (nitrogen solubility index).

In practice, the part of the press cake returned in form of collets may have a maximum particle size of 4 to 6 mm, preferably of 5 mm. Thus, the returned part may particularly be fines and fragments of collets to which the entire press cake is expanded after the supply of the pressurized steam and which is predominantly further processed in another way, particularly by extracting. Fines smaller than 1 mm may be returned to the press cake already prior to producing the collets or pellets. Depending on the hull percentage of the respective seed, the returned part of the press cake replaces the previously separated hulls, for which reason the returned part may make up to 30% of the press cake and thus also of the mass to be pressed. Depending on the type of the press, the suitably returned part is above 5% and often between 10% and 15% of the press cake.

Not only the collets which are directly formed of the press cake by means of the expanding are suitable for the returning and increasing the friction in pressing the low-hull grain fraction. Also the collets which remain after an extraction which an organic solvent for reducing their residual oil content are suited and may be sieved-off with a maximum size of 5 mm, dried and returned to the pressing.

Surprisingly, it becomes apparent that the collets or pellets increase the fraction and thus the performance in pressing-out the cold oil without decreasing the quality of the pressed oil. Instead, the throughput and the press performance increase with unchanged power input, and, thus, the cake temperature is also limited.

It proves to be advantageous, if the returned part of the press cake is cooled down to a temperature of below 50° C. or to a temperature of 20 to 35° C. and preferably to a temperature of 25 to 30° C., i.e. of about ambient temperature, so that the pellets or collets are strong and hardly deformable before they are added to the low-hull grain fraction.

In practice, the grains of the respective oil-containing seed can be hulled in that they are passed through a roller nip between hulling rollers. Alternative hulling methods which results in a similar result (for example impact hulling) are also applicable. Next, hulls can be separated from the low-hull grain fraction by at least one of sieving and air separating to such an extent that the hulls remaining in the low-hull grain fraction to do not make up for more than 4 percent by weight of the low-hull grain fraction. The cold-pressed core oil is pressed from the low-hulled grain fraction, wherein a water content of the low-hull grain fraction may be from 4 to 7 percent by weight, wherein a cake temperature in the press cake being generated is limited to 70° C., and wherein a residual oil content can be reduced to 8 to 28 percent by weight and preferably to 8 to 16 percent by weight of a dry matter of the press cake.

The pressurized steam can be supplied to the entire press cake, and the entire press cake can be expanded to form collets afterwards, wherein the steam can be metered such that the press cake, under the influence of the steam, is temporarily is heated up to above 100° C. and the collets, after the expanding, have a temperature of 80° C. to 95° C. By means of cooling this temperature is to be reduced further to below 60° C. Then, after the expanding, a part of the collets is returned, mixed with the low-hull grain fraction prior to the pressing and pressed once again.

These collets could already as such be used as animal feed or after milling as food stuff. Due to the heating up of the press cake, they are hygienically harmless and nevertheless have an advantageous amino acid composition with at the most little undesired protein denaturations due to the short time of this heating up.

Particularly, the collets have a continuous but open structure which is advantageous for their further processing as it will be described in the following, and which can be kept during their processing.

If necessary, the method according to the present disclosure may start with cleaning the grains of the oil-containing seed to remove contaminations like stones or chaff. The purified grains may be subjected to a classification by grain size to remove grains which are not well suited for the subsequent hulling of the grains. In practice, in case of a rape seed, grains smaller than a minimum size between 1.2 mm and 1.8 mm, preferably about 1.4 mm, and bigger than a maximum size between 2.6 and 3.0 mm, preferably of about 2.8 mm can be removed. The grains exceeding the maximum size may be hulled with a device adapted to their grain size, and the grains with a grain size below the minimum size may be used otherwise. Typically. the portion of smaller grains is below 8 percent by weight, often below 4 percent by weight.

Already earlier or afterwards, the grains may be adjusted for the hulling to a moisture content between 4 and 7 percent by weight, preferably of about 5 percent by weight and dried for this purpose, if needed. If applicable, the drying temperature should be selected such that a grain temperature of 70° C., preferable of 65° C., is not exceeded to avoid a protein denaturation during the drying. For crushing the hulls, the grains are passed through a roller nip between hulling rollers which is typically at least 20% smaller than the minimum size of the grains. The grains may also successively pass through a plurality of roller nibs with decreasing size.

Afterwards, the grains which have been crushed between the hulling rollers or by other hull crushing hulling methods (i.e. impact hulling) are separated in the low-hull grain fraction and a high-hull grain fraction, particularly by at least one of sieving and air separation which may include aspiration of the hulls. Where possible, the hulls remaining in the low-hull grain fraction do not make up more than 4 percent by weight. Preferably they are not more than 3.5 percent by weight.

In air separation, a yield of the low-hull grain fraction of typically more than 75% and preferably about 80% can be achieved. The high-hull grain fraction is complementary to the low-hull grain fraction so that the yield of high-hull grain fraction is between 20 and 25% of the weight of the oil-containing seeds used.

In the high-hull grain fraction, cores and core fragments which make up to 40 percent by weight of the high-hull grain fraction are still found. Thus, the high-hull grain fraction is suitably processed further. This may be accomplished by known methods like pressing out oil at temperatures above 90° C. or solvent extraction of the high-hull grain fraction, particularly with hexane or absolute alcohols. Alternatively, the high-hull grain fraction may be mixed with water of about 20 to 30° C., i.e. room temperature or about 25° C., which causes a swelling of the fibers contained in the cores or the core fragments and thus a flotation of the cores or core fragments, to obtain a further low-hull grain fraction.

Due to another morphology, the swelling does not or at least not to same extent occur in the fibers contained in the hulls. Further, the cores or core fragments differ from the hulls due to a higher oil content. After the swelling of the fibers in the cores, the cores have a smaller density than water, whereas the hulls still have a higher density than water. Correspondingly, a flotation of the cores occurs, wherein the flotation and the concomitant separation of cores and hulls can be supported by at least one of introducing fine gas bubbles and gentle low-shear stirring. The floated cores are taken-off as the further low-hull grain fraction. They may be dewatered via a band press and added to the already previously separated low-hull grain fraction. This addition may take place already prior to the pressing of the cold-pressed core oil or even later. However, the addition of the further low-hull grain fraction to the main material stream preferably takes place prior to the supplying of the pressurized steam and the subsequent expanding to form the collets. The separated hull fraction can be separated due to its higher density than water, purified further, and then, for example, used thermally or in a biogas plant.

After the hulling and prior to the pressing, the low-hull grain fraction may be rolled to flakes and be passed through at least one roller nip formed by flaking rollers for this purpose. In doing so, the temperature of the flakes can be kept below 45° C. The flakes preferably have a flake thickness of 0.1 to 0.8 mm.

The pressing of the low-hull grain fraction occurs without adding additional heat. However, an increase in temperature occurs due to the work provided in pressing. According to the present disclosure, this increase in temperature is limited to a maximum cake temperature in the press cake being generated to 70° C. Thus, a trans fatty acid content of the cold-pressed core oil of 0.2% is safely kept and often undercut by far.

During pressing, the cold-pressed core oil can be collected in a first oil fraction which is not heated up to more than a first limit temperature in the pressing, and in a second oil fraction which is heated up to more than the first limit temperature in the pressing. Then, the first oil fraction has the smallest thermal influence on its oil composition, and it is the highest value core oil obtained in the method according to the present disclosure. The second oil fraction is also high-value cold-pressed core oil according to the Codex Alimentarius. Even a third oil fraction may be collected which has been heated up to more than a second limit temperature during pressing. The first limit temperature between the first and the second oil fraction may be between 35 and 50° C. Preferably, it is 40° C. Then, with the maximum cake temperature of 70° C., the first oil fraction has an average temperature of 32 to 36° C. and clearly less than 0.1% trans fatty acids, whereas the second oil fraction has an average temperature of 40 to 50° C. and at least clearly less than 0.2% trans fatty acids. The second limit temperature between the second and any third oil fraction may be about 60° C.

In the pressing according to the present disclosure at cake temperatures of not more than 70° C., the low-hull grain fraction—depending on the oil seed—can be pressed down to a residual oil content of the press cake of 6 to 28 percent by weight of its dry matter or of 8 to less than 18 percent by weight of its dry matter and preferably of about 10 to 16 percent by weight of its dry matter. The cold-pressed core oil may in a usual way be processed by at least one of filtration and sedimentation and provides cold-pressed native core oils of food stuff quality.

The press cake obtained from the pressing may be comminuted or used directly, and a further low-hull grain fraction obtained by flotation or what is remaining after pressing may be added thereto before the pellets or collets are formed.

Non-returned collets may be extracted with a solvent to reduce the collets to a residual oil content of less than 2 percent by weight or of 0.3 to 1.3 percent by weight of their dry matter. As the solvent, besides hexane, any other organic solvent may be used in which oil dissolves well, like for example isopropanol. The use of azeotropic or absolute or pure alcohol in form of ethanol is also possible. This may particularly be bio alcohol so that bio protein products accrue when oil-containing bio seed is processed.

The preceding treatment of the collets is in two ways particularly advantageous for bio products, because the collet structure forms a large stable inner surface. On the one hand, it is possible to re-de-oil with nearly water free (absolute) bio ethanol, which is produced as bio fuel at a large scale, instead of hexane without strongly denaturing the proteins; on the other hand, in further processing into protein concentrate, the intermediate drying is omitted which is necessary when using hexane. A solvent exchange is also not necessary. Thus, the extraction with solvent is strongly simplified.

Thus, a solvent based oil extraction is available which can replace the hexane extraction at a large scale and which makes de-oiling the protein of the press cake more secure, less toxic and cheaper than achievable which hexane. The emissions which can not be avoided in large scale production, are considerably reduced, because the condensability of ethanol is much better than that one of hexane. As a result, toxic environmental loads are reduced in obtaining vegetable oil at an industrial scale. In this embodiment of the method according to the present disclosure, traces of the toxic hexane in the final product are also avoided. Further, ethanol is permitted as an additive to bio products. Thus, the production of protein and other byproducts like seed inherent fibers and dietary fibers of bio quality is possible.

Both for the extraction and for all other previously described steps of the method according to the present disclosure, industrial standard technologies can be used, particularly, carousel extractors and band extractors. The solvent used encloses the collets in a percolation, wherein a miscella of the solvent accrues in which oil contained in the collets is dissolved. The miscella is separated from the solvent by distillation in a known way such that the oil remains. This oil is extracted core oil.

The extracted collets can be dried and comminuted, wherein a high protein containing meal with a protein content of more than 45 percent by weight, preferably of more than 48 percent by weight protein in the dry matter accrues, which, like HP soy bean meal is nearly free of hulls. This core meal may be further processed by means of known techniques.

One possible further processing of the collets dried after the extracting with the organic solvent is the alcohol-water extraction for removing non-proteinogenic ingredients and enriching the proteins to a protein concentrate.

The most low-cost and most secure processing of the collets accruing in the course of the method according to the present disclosure is that the alcohol-wet collets are further processed without drying. Because alcohols, particularly ethanol, can be mixed with water in any ratio, the polarity of the extracting agent is increased so that it becomes suitable for removing polar ingredients, like for example plant-inherent sugars. Additionally, the alcohol-wet collets remain elastic and thus result in a reduced abrasion or fracture of the collets and do thus not have to be sieved prior to further processing which is the case after extracting with the organic solvent hexane. Even the solvent exchange is avoided, what further simplifies the extraction.

The further processing of collets which have been dried after the extracting with the organic solvent hexane also takes place via the alcohol-water extraction for removing non-proteinogenic ingredients and enriching the protein to a protein concentrate. For this purpose, the collets are first sieved to remove fines and collet fragments which unavoidably accrue due to the mechanical load during drying. If these fines are used to increase the friction of the cold-pressing, a sieve is selected which holds back particles starting at 5 mm; if the material is further processed in an alcoholic extraction, an exclusion of 1 mm is sufficient.

Next, the collets which have been reduced by the fines are subjected to a swelling in the alcohol-water mixture, 15 minutes being sufficient for this purpose. The swelling should be destruction-free before the collets saturated with the alcohol-water mixture are forwarded to a further band extraction which may take place analogously to the extraction with the organic solvent. A suitable simple implementation is to arrange a swelling screw upstream of the band extraction in order to continuously implement the swelling. However, all other technical measures which allow for a continuous swelling are suitable. Even with a direct further processing of the still alcohol-wet collets after their first extraction with the absolute alcohol instead of hexane, the swelling in the alcohol-water mixture is beneficial.

The swelling may be operated with the alcoholic miscella of the alcoholic band extraction which would have corresponded to the discharge towards the distillation. Thus, the swelling screw leads towards a further extraction stage.

Alternatively, the collets extracted with the organic solvent may be processed further directly, i.e. without drying or comminution.

Thus, prior to the discharge out of the solvent-extractor, the collets may be de-moistened by simple drainage and draining the organic solvent in order to not destroy the structure of the collets and to not produce fines for this reason. In this way, typically more than 50% of the solvent may be removed from the collets. At the exit of the solvent-extractor, the collets are, without destruction, taken up and moved-on by a conveying unit, like for example a conveying screw or a conveying belt. The conveying unit conveys the solvent-wet collets without shearing to a filter which is subdivided in separation areas. Without destruction, the material is passed onto the filter. The filter may be a closed rotating filter or band filter, particularly a vacuum band filter. A rotary gate valve may be installed between the conveying unit and the filter to achieve a delimitation of the solvent areas. After the solvent wet collets have been arranged on the filter, the filter is moved into a first position in which the solvent content of the solvent wet collets is further reduced. This may be accelerated by applying a vacuum to the vacuum band filter. Thus, a solvent content of below 40 percent by weight can be achieved. In doing so, the solvent, due to the capillary effect, has been concentrated towards the filter so that a low-solvent layer is formed in the capillaries in the collets above the solvent, which only wets the surfaces of the capillaries of the collets. When the organic solvent is hexane, pure alcohol or a water-alcohol azeotrope may be layered on top to replace the hexane. Due to the resulting layering of the solvent in the collets, there is a nearly plane alcohol-hexane boundary layer so that only a small hexane-alcohol-water mixed fraction accrues. After two to three washings steps, the hexane in the structure of the collets is replaced by alcohol without residuals. Only small volumes of a hexane-alcohol mixed fraction accrue which can be separately processed by distillation. This example is exemplary. Any other technical device which allows for a solvent exchange may be used.

An extraction of the collets with an aqueous alcohol solution in order to obtain a purified protein concentrate may follow to the solvent exchange, the extraction with absolute alcohol or the drying of the hexane-extracted collets. Here, the aqueous alcohol solution may comprise 70 to 96 percent by volume alcohol. Preferred are 80 to 90 percent by volume alcohol. This alcohol extraction, particularly with ethanol, serves for removing toxins and other anti-nutritive ingredients. At the preferred alcohol concentration, the swelling of the fibers contained in collets and thus the increase in volume remains small. In this way it is also avoided that the percolation rates of the collets strongly decrease due to swelling. A too strong swelling would close the capillaries of the collets. Preferably, the collets are extracted with the aqueous alcohol solution in countercurrent. In doing so, a ratio of dry matter to solvent of 1 to 2 to 1 to 6 is suitable. Preferably, at least 10 extraction stages are passed in countercurrent. Close to the end of the extraction, a replacement washing with azeotropic, i.e. 96% alcohol or absolute alcohol, may take place, to simplify the drying of the extracted material. The extracts from the extraction stages are collected. After distilling-off the alcohol, a molasses remains.

The azeotropic water-alcohol solution or the absolute alcohol may be collected separately and used for replacing hexane by alcohol in the solvent exchange zone. An advantage of doing so is that the recovery of the alcohol-water mixture of the alcohol-water extraction needs no rectification and may thus remain compact. The rectification with small volumes is reserved for the solvent exchange which separates the hexane-alcohol-water mixture.

An alcohol extraction may also be carried out under production of a suspension by milling in the aqueous alcohol solution. The suspension is then purified over at least one of centrifuges, strainers and filters in countercurrent. This may be executed as the only aqueous alcohol extraction or in addition to an existing band extraction. Vacuum band extractors are also suitable for the alcohol washing of the suspension.

The suspension washing is particularly suited for an after-treatment after the provided band extraction, because many contaminations are immobilized in the collets which only get free with opening of the collets. Thus, the suspension washing fulfills the task of a fine-purification in order to increase the quality of the protein concentrate and the protein percentage.

The purified protein concentrate may be dried by toasting, flash drying or vacuum drying. The dried protein concentrate has a protein percentage of above 60% by weight related to its dry matter.

An apparatus for carrying out the method according to the present disclosure for obtaining cold-pressed core oil at an industrial scale has hulling rollers forming a roller nip for hulling the grains of the respective oil-containing seed, a separation device arranged downstream of the roller nip and having at least one sieve or an air separator for separating the low-hull grain fraction from a high-hull grain fraction, flaking rollers for rolling the low-hull grain fraction to flakes, a screw press for pressing the cold-pressed core oil from the flakes, wherein the screw press outputs a press cake, and a return device which is configured to return a part of the press cake to the screw press. An expander for supplying pressurized steam to the press cake and for afterwards expanding the press cake to form collets or a pelletizer for compressing the press cake to form pellets are arranged downstream of the screw press, and the return device is configured for returning a part of the press cake after the expander, i.e. in form of a part of the collets, or after the pelletizer, i.e. in form of a part of the pellets.

An extractor can be arranged downstream of the expander, the extractor being configured for extracting the collets with an organic solvent. In practice, the return device may be configured for separating the returned part of the press cake by sieving a particle fraction having a maximum particle size in the range of 4 to 6 mm from the collets. This sieving may take place prior to or after, or both prior to and after the extraction with the organic solvent in the extractor.

The pelletizer may have a heating device to heat up the press cake temporarily to a above 100° C. in pelletizing.

The return device may have a cooler which is configured for cooling the returned part of the press cake. The cooler may, for example, include a cooling air fan which results in cooling the part of the press cake by evaporation cooling due to evaporation of the moisture contained.

The screw press may have a press screw rotating about a horizontal rotation axis and a sieve box, wherein, in an oil collection basin arranged beneath the sieve box, a weir running cross-wise with regard to the rotation axis, which separates an at first pressed-out first oil fraction and later pressed-out second oil fraction of the cold-pressed core oil in the oil collection basin from one another, is movable in direction of the rotation axis. By moving the weir, the above explained first limit temperature between the first and the second oil fraction can be adjusted. When a drive is provided which drives the weir in direction of the rotation axis depending on a signal of at least one oil temperature sensor arranged at the weir, the first limit temperature may be close-loop controlled to the predetermined value, even if the temperature distribution over the screw press varies. The sieve box of the screw press may be made of strainer bars.

Further, the apparatus according to the present disclosure may have a flotation basin for separating the high-hull grain fraction by flotation in water into a further low-hull grain fraction and a hull fraction. Optionally, the flotation basin may have at least one of a pressurized air connector opening close to its bottom and a stirrer.

An extractor arranged downstream of the expander may further be configured for drying the collets or to subject the still solvent-wet collets to a solvent exchange and to then extract the collets with an aqueous alcohol solution.

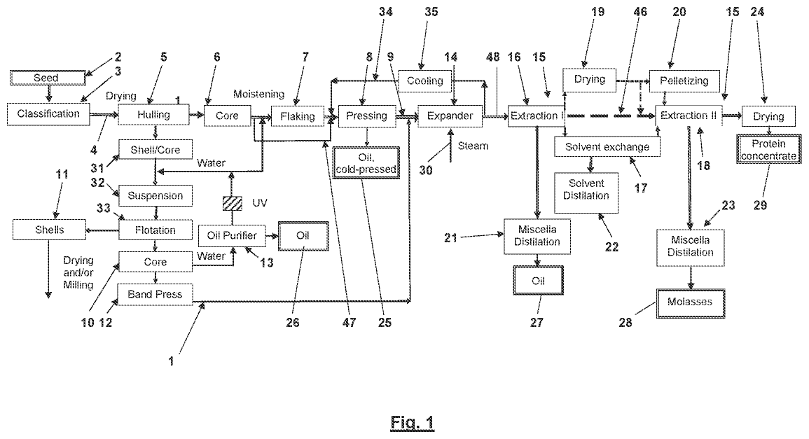

Now referring in greater detail to the drawings, FIG. 1 illustrates

In a block diagram, FIG. 1 shows an apparatus 1 according to the present disclosure and, at the same time, the workflow of a method according to the present disclosure. Oil-containing seed out of a silo or hopper 2 is subjected to a classification and cleaning in a sieving unit 3. From the sieving unit 3, cleaned grains 4 within a predetermined grain size range are obtained. After drying, if needed to adjust a moisture of the grains 4 of about 5% by weight, the grains are hulled by means of hulling rollers 5 which form a roller nip and which are combined with a downstream separation device. A low-hull grain fraction 6 and a high-hull grain fraction 31 result. The low-hull grain fraction 6 is rolled to flakes by flaking rollers 7, or directly further processed on the way of a direct further processing 47. In a screw press 8, cold-pressed core oil 25 is pressed from the flakes or the low-hull grain fraction 6. A resulting press cake 9 is supplied to an expander 14.

On the other hand, water is added to the high-hull grain fraction 31 to form a suspension 32 in which the fibers contained in a core portion of the high-hull grain fraction 31 swell. Afterwards, a flotation 33 occurs in which a further low-hull grain fraction 22 floats and thus separates from a hull-fraction 11. The hull-fraction 11 may be dried or ground or both dried and ground and, for example, be used in an incinerator or biogas plant. The further low-hull grain fraction 10 is pressed in a belt press 12. Its solid content is added to the press cake 9 in front of the expander 14. Water pressed off by the belt press 12 is processed in an oil clearer 13 in which oil 26 is separated. The purified water is UV-treated for disinfection and used again. The press cake 9 and the further low-hull grain fraction 10 are comminuted and then supplied to the expander 14. In the expander 14, the temperature of the press cake 9 is, for a short term, increased to above 100° C., typically up to 140° C., by supplying pressurized steam 30. When exiting out of the expander, the steam decompresses and cools down the material exiting in form of collets 48 to 80 to 95° C. In an extractor 15, the collets 48 are at first subjected to a solvent extraction 16 with, for example, hexane ore pure or absolute alcohol, preferably ethanol, as an extraction I. In case of pure or absolute alcohol, a direct further processing 46 with direct transition from the solvent extraction 16 in the extractor 15 to an aqueous alcohol extraction 18 as an extraction II may take place. Otherwise the aqueous alcohol extraction 18 takes place after solvent exchange 17 or drying 19 of the solvent-extracted collets. Pelletization 20 or a further expansion of the dried material may follow, or a protein meal resulting from the drying 19 is output as a product.

The alcohol extraction 18 may also be carried out with collets resulting from the drying 19 or with the protein meal. In a distillation 21, core oil 27 extracted from the miscella of the solvent extraction 16 is obtained. In a distillation 22, solvent from the solvent exchange 17 is recovered. A molasses 28 results from a distillation 23 of the alcoholic extract from the alcohol extraction 18. A drying 24 of the residue of the alcoholic extraction 18 results in a purified protein concentrate 29.

A returning device 34 returns a part of the press cake 9 after the expansion at the output of the expander 14 back into the screw press 8. In practice, fines are sieves off the collets 48 exiting the expander 14, cooled down with a cooler 35 of the return device 34 down to a temperature <35° C., and then added to the rolled low-hull grain fraction 6 to increase the friction in the screw press 8. A certain friction of the pressed low-hull grain fraction 6 and the screw press 8 is required to achieve a sufficient pressing performance with regard to the employed mechanical energy and thus also with regard to the heating up of the press cake 9 formed in the screw press 8 as well as the residual oil content of the press cake 9. This friction is provided by the cooled down collets, without hygienic problems due to the return of a part of the press cake 9 into the screw press 8, because the collets are made hygienic by the expansion in the expander 4. Further, the collets 3 have better mechanical properties for increasing the friction in the screw press 8 than the press cake 9 in front of the expander 14.

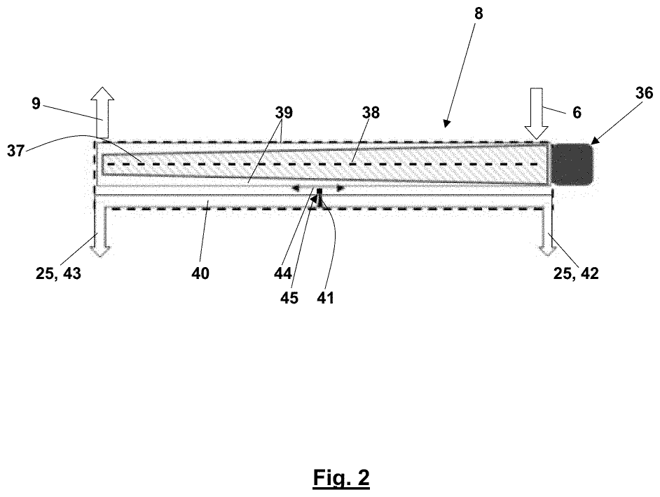

The embodiment of the screw press 8 of the apparatus 1 according to the present disclosure depicted in FIG. 2 has an electric drive 36, which rotates a press screw 37 about a horizontal rotation axis 38 with respect to a sieve box 39 to press the core oil 25 from the low-hull fraction 6, wherein the press cake 9 is generated. In direction of the rotation axis 38, at first a first oil fraction 42 is pressed in which the core oil 25 does not exceed a limit temperature. Afterwards, a second oil fraction 43 is pressed which still consists of cold-pressed core oil, because no heat is added to the screw press 8. However, there is a temperature increase in the screw press 8 along the rotation axis 38 due to the screw press 37 acting upon the low-hull grain fraction 6. This increase in temperature is limited to a maximum cake temperature of the press cake 9 of 70° C. Thus, also the second oil fraction 43 has a trans-fatty acid content of less than 0.2%. The trans-fatty acid content of the first oil fraction is below 0.1%. In an oil collection basin 40 arranged below the sieve box 39, the two oil fractions 42 and 43 are separated by a weir 41 extending crosswise with respect to the rotation axis 38. Depending on an oil temperature sensor 45 arranged at the weir 41, the weir 41 is shifted along the rotation axis 38 by a drive 44 which is indicated here by means of a double arrow such that the oil temperature sensor 45 does not sense a higher temperature than the limit temperature of the first oil fraction 42.

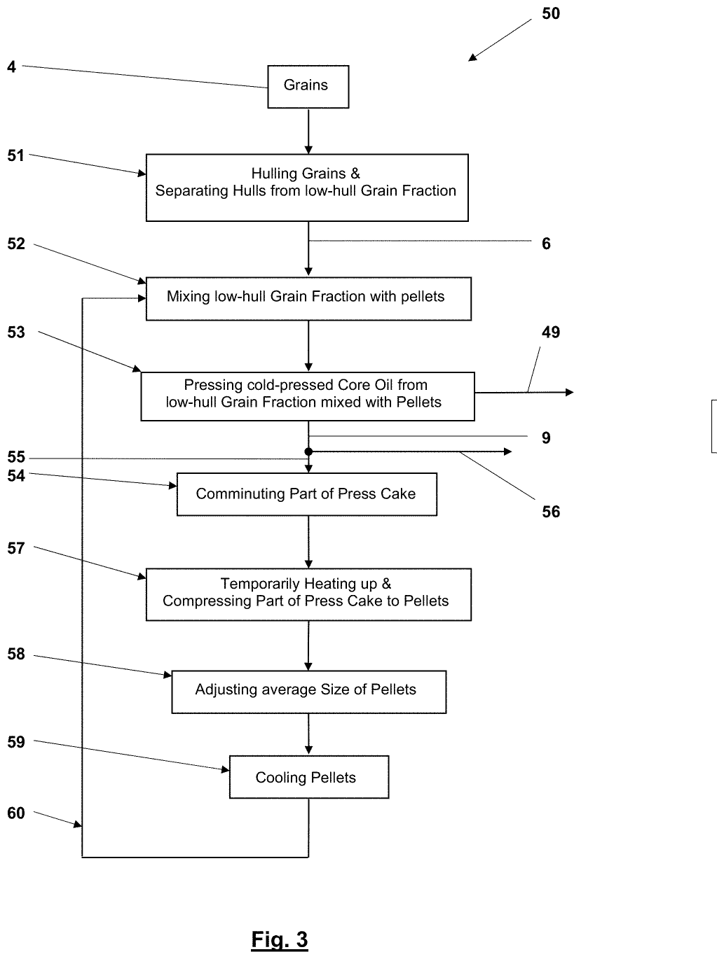

The workflow 50 of another method according to the present disclosure depicted in FIG. 3 starts with a step 51 of hulling the grains 4 of the oil-containing seed and of separating hulls from the low-hull grain fraction 6 of the oil-containing seed. Next, in a step 52, the low-hull grain fraction 6 is mixed with pellets 60 serving as a pressing aid. In a step 53, cold-pressed core oil is pressed from the low-hull grain fraction 6 mixed with the pellets 60. In the step 53, the cake temperature in the press cake 9 being generated is limited to 70° C. For this purpose, heat 49 may be removed from the low-hull grain fraction 6 mixed with the pellets 60. At least, no heat is added in step 53. In a step 54, a part 55 of the press cake 9 is taken and comminuted, whereas a remainder 56 of the press cake 9 is further processed separately. In a step 57, the comminuted part 55 of the press cake is temporarily heated up to above 100° C. while being compressed to form pellets. In a step 58, an average size of the pellets is adjusted to be in a range from 50% to 300% of at least one of an average particle size of the low-hull grain fraction 6 and an average particle size of the grains 4 of the oil-containing seed. In a step 59, the pellets are cooled down to a temperature below 60° C., preferably to a temperature in a range from 20 to 35° C. The cooled pellets 60 are returned to the step 52 of mixing so that, in the step 53, the cooled pellets 60 mixed with the low-hull grain fraction 6 are pressed. This means that the material of the pellets 60 which has been pressed in the step 53 before is now pressed once again. The sequence of the steps 58 and 59 is not relevant. i.e. the pellets may be cooled earlier or even later than depicted in FIG. 3. It is only relevant that the pellets 60 have been cooled down when being pressed in the step 53. At the end, the cooled pellets make up 5 to 30 percent by weight of the press cake 9, and a residual oil content of the press cake 9 is in a range from 8 to 22 percent by weight of the dry matter of the press cake 9.

### EXAMPLES

The following examples relate to the method according to FIG. 1.

### Example 1

Grains of a rape seed have a size of 1.2 to 3 mm. The average size of the crushed collets returned to pressing-out the core oil is adjusted to 5 mm, wherein at least 50% by weight of the returned collets have the size of 5 mm. The grains are hulled with the hulling rollers 5 adapted to rape. The hull proportion of the German 00 rape used is 14%. The remainder of the hulls which for technical reasons remains with the cores in the low-hull grain fraction is 2.5%.

75 kg crushed collets of the average size of 5 mm are added to 1000 kg of the low-hull grain fraction having a moisture content of 5% by weight as a pressing aid and mixed intensely. This mixture is supplied to the screw press 8. The input temperature is 24° C. The press cake 9 exits at a temperature of 65° C., the residual oil content in the press cake 9 is 12%.

The exiting cold-pressed rape core oil is collected in the oil collecting base 40 in two oil fractions 42 and 43 separated at 40° C. by means of the weir 41.

The first oil fraction 42 is native cold-pressed virgin core oil and has a content of trans fatty acids below 0.1%. The percentage of virgin core oil is about 40% of the entire cold-pressed core oil. The second oil fraction 43 with temperatures between 41 and 58° C. is native cold-pressed core oil and has a content of trans fatty acids below 0.15% and makes up about 60% of the collected core oil. Both oil fractions 42 and 43 together amount to about 0.38 tonne of cold-pressed core oil. The press cake 9 exiting out of the screw press 8 has a residual oil content of 12% by weight. The exit temperature of the press cake 9 out of the screw press 8 is 65° C.

740 kg press cake are comminuted and heated up in the expander 14 by means of addition of pressurized steam 30 such that, after the exit out of the expander 14 a temperature of 83° C. is achieved in the collets. The collets are cooled. The cooled collets are crushed by means of a roller crusher into particles smaller than 5 mm. 120 kg of the crushed collets are mixed with the low-hull grain fraction; the remaining 620 kg (steady state) of the crushed collets are milled into a protein meal. The protein content of the protein meal is about 37%. The NSI-value of the protein meal is above the value of native raw protein measured in rape.

The returned partial flow of the collets may be cooled down prior to crushing down to about 30° C.

### Example 1a

Deviating from the previous example 1, the remaining 620 kg (steady state) of the collets are not milled into a protein meal but supplied to a band extractor, and percolated in the extraction I with hexane in countercurrent. The miscella is distillated and results in about 160 kg oil. The hexane-wet de-oiled collets are drained and mildly dried by means of a toaster conserving the collet structure. About 12 kg fines are sieved off the collets. The remaining collets are supplied to a second band extractor via a tube screw serving as a swelling screw. In the tube screw, the collets swell in the drained-off extract of the second band extractor in aqueous alcohol. Afterwards, the pre-swollen collets are de-sugared on the second band extractor with an alcohol-water mixture of 80 to 20 percent by weight in the extraction II. A further, final extraction step is carried out with azeotropic ethanol. The alcohol is recovered. The collets are forwarded to a vacuum paddle dryer and slowly dried at 50 mbar and 45° C. for 1 hour. Subsequently, the dried collets are milled. About 300 kg rape protein concentrate having a NSI of 75% and a protein content of about 64% related to the dry matter are generated.

### Example 2

Soybeans have a size of 6-11 mm. The maximum size of the crushed collets returned to the pressing of the core oil is adjusted to 15 mm. The soybeans are hulled with the hulling rollers 5 adapted to soy. The hull percentage of the soybeans used is 8%. The remainder of the hulls which for technical reasons remains with the cores in the low-hull grain fraction is 1.5%.

1 tonne hulled soybeans are rolled to flakes by means of the flaking rollers 7. The low-hull grain fraction is only rolled to such an extent that a temperature of the flakes is kept below 45° C. In order to keep this temperature, the flaking rollers 7 may be cooled. Prior to cold pressing, the collets of the average size of 15 mm are added to the flakes and mixed intensely. Then, this mixture is supplied to the screw press 8.

In the screw press, the low-hull grain fraction with the added collets is compressed. The exiting cold-pressed core oil is separately collected for different temperature ranges. The first oil fraction 42 with a temperature of below 42° C. is virgin soy core oil. The second oil fraction 43 between 43 and 60° C. is native cold-pressed soy core oil. It becomes apparent that the collets result in that the portion of the virgin soy core oil is about 30% of the collected cold-pressed soy core oil. Both oil fractions 42 and 43 together at up to about 0.8 tonne cold-pressed soy core oil. The press cake 9 exiting out of the screw press 8 has a residual oil content of 10 percent by weight, the protein content is about 47%. The exit temperature of the press cake 9 exiting out of the screw press 8 is 68° C.

The press cake 9 is comminuted and heated up in the expander 14 under addition of pressurized steam 30 such that, after the exit out of the expander 14, a temperature of 85° C. is achieved in the collets. The collets are cooled. The cooled collets are crushed by means of a roller crusher into particles smaller than 15 mm. A part of the crushed collets is mixed with the flakes; the other part of the crushed collets is processed into a protein meal. The protein content is about 47%. The NSI value of the protein meal has the value of native raw protein.

### Example 2b

Deviating from or in addition to the example 2, the comminuted press cake 9 is heated in the expander 14 under addition of pressurized steam 30 such that after the exit out of the expander 14 a temperature between 85° C. and 90° C. is achieved in the collets. For the returning, a partial flow of the cooled collets is crushed via the roller crusher into particles smaller than 10 mm. The returned part of the crushed collets is mixed with the flakes. The uncrushed collets are further processed in the extraction I. The protein content of the collets is about 46%, the NSI value is about 85%.

In the extraction I, the collets are extracted on a band extractor with hexane like in example 1, dried, de-sugared with aqueous alcohol of 75% via the extraction II, dried in a vacuum dryer and milled afterwards. The protein content is about 71% of the dry matter, the NSI is 75%. About 300 kg soy protein concentrate are obtained.

### Example 3

Hulled soybeans are directly supplied to the screw press 8, pressed and processed into the collets mentioned in example 2. A partial flow of the collets, whose amount corresponds to the amount of the hulls removed in the hulling, is crushed to 10 mm and added to the hulled soybeans in front of the screw press 8. The remaining collets are extracted in the extraction I on a first band extractor with absolute ethanol at 60° C. in several stages via percolation. The miscella generated is distilled, wherein ethanol of at least 90%, preferably azeotropic ethanol is obtained. The ethanol is de-watered by molecular sieves (made absolute) and returned to the process. The extraction time is between 1 and 3 hours, preferably about 2 hours. In doing so, an ethanol to collet ratio of 2.5:1 to 3:1 is adjusted. After exhaustive extraction, the ethanol is at first drained off the collets. A drying of the collets for removing the remaining ethanol is not necessary. The extraction II on a second band extractor with upstream swelling screw uses aqueous ethanol in countercurrent. The extraction temperature remains at 60° C. The aqueous ethanol to collet ratio is about 4:1 to 5:1. The extraction period is 2 hours at maximum. The alcohol-wet collets are subjected to a suspension-washing for fine-purification directly after discharge out of the second band extractor. For this purpose, the collets are milled in aqueous alcohol via a rotor-stator system to about 50-150 nm, filtered via press-filters, re-washed with absolute ethanol, and reduced in alcohol content by compression. The filter cake is dried in a vacuum paddle dryer at 50 mbar and 55° C. A soy protein concentrate of 295 kg, a protein content of 74% related to the dry matter and a NSI of 80% is generated.

Many variations and modifications may be made to the preferred embodiments of the invention without departing substantially from the spirit and principles of the invention. All such modifications and variations are intended to be included herein within the scope of the present invention, as defined by the following claims.

1. A method of obtaining cold-pressed core oil at an industrial scale, the method comprising the steps of:
hulling grains of an oil-containing seed other than rape seed and separating hulls from a low-hull grain fraction of the oil-containing seed,
pressing the cold-pressed core oil from the low-hull grain fraction, wherein a cake temperature in a press cake being generated in pressing is limited to 70° C.,
temporarily heating up a part of the press cake to above 100° C.,
supplying pressurized steam to the part of the press cake,
expanding the part of the press cake and the pressurized steam to form collets,
returning and mixing the collets with the low-hull grain fraction prior to the pressing,
cooling the collets down to a temperature below 60° C.,
and
pressing the cooled collets mixed with the low-hull grain fraction once again.

2. The method of claim 1, wherein a weight-averaged average size of the collets mixed with the low-hull grain fraction is at least 100% and at maximum 400% of at least one of an average particle size of the low-hull grain fraction and an average particle size of the grains of the oil-containing seed.

3. The method of claim 2, wherein the weight-averaged average size of the collets mixed with the low-hull grain fraction is at maximum 300% of at least one of the average particle size of the low-hull grain fraction and an average grain size of the grains of the oil-containing seed, if at least one of the average particle size of the low-hull grain fraction and the average grain size of the grains of the oil-containing seed is more than 5 mm.

4. The method of claim 1, wherein the pressurized steam is metered such that the press cake, under the influence of the pressurized steam, is temporarily heated up to above 100° C., and that the collets, after the expanding, have a temperature from 80° C. to 95° C.

5. The method of claim 4, wherein the pressurized steam is supplied to the entire press cake is, wherein the entire press cake and the pressurized steam are expanded to form collets, wherein the collets are extracted with a solvent, wherein the collets mixed with the low-hull grain fraction are taken from the collets prior to the extracting or after the extracting or both prior to and after the extracting.

6. The method of claim 5, wherein the collets are extracted with pure alcohol and then, without previous drying, subjected to swelling in an alcohol-water mixture and a subsequent further extraction with the alcohol-water mixture.

7. The method of claim 1, wherein the press cake is comminuted prior to supplying the pressurized steam.

8. The method of claim 1, wherein, in the step of pressing, the cooled collets mixed with the low-hull grain fraction have a temperature in a range from 20 to 35° C.

9. The method of claim 1, wherein, in the step of pressing, the cooled collets make up 5 to 30 percent by weight of the press cake.

10. The method of claim 1, wherein, in the step of pressing, a residual oil content of 8 to 22 percent by weight of a dry matter of the press cake is adjusted.

11. The method of claim 1, wherein, in the step of pressing, the cooled collets and the low-hull grain fraction are pressed without addition of heat or while removing heat.

12. A method of obtaining cold-pressed core oil at an industrial scale, the method comprising the steps of:
hulling grains of a rape seed and separating hulls from a low-hull grain fraction of the rape seed,
pressing the cold-pressed core oil from the low-hull grain fraction, wherein a cake temperature in a press cake being generated in pressing is limited to 70° C.,
temporarily heating up a part of the press cake to above 100° C.,
supplying pressurized steam to the part of the press cake,
expanding the part of the press cake and the pressurized steam to form collets,
returning and mixing the collets with the low-hull grain fraction prior to the pressing,
cooling the collets down to a temperature below 60° C.,
and
pressing the cooled collets mixed with the low-hull grain fraction once again,
wherein the low-hull grain fraction comprises at least one of more than 4% by weight hulls and
a water content
of less than 4% by weight or
of more than 7% by weight,
or a residual oil content of the press cake is reduced to less than 18% by weight of a dry matter of the press cake, or
wherein the low-hull grain fraction comprises at least one of more than 4% by weight hulls and
a water content
of less than 4% by weight or
of more than 7% by weight,
and a residual oil content of the press cake is reduced to less than 18% by weight of a dry matter of the press cake.

13. The method of claim 12, wherein a weight-averaged average size of the collets mixed with the low-hull grain fraction is at least 100% and at maximum 400% of at least one of an average particle size of the low-hull grain fraction and an average particle size of the grains of the oil-containing seed.

14. A method of obtaining cold-pressed core oil at an industrial scale, the method comprising the steps of:
hulling grains of an oil-containing seed and separating hulls from a low-hull grain fraction of the oil-containing seed,
pressing the cold-pressed core oil from the low-hull grain fraction, wherein a cake temperature in a press cake being generated in pressing is limited to 70° C.,
temporarily heating up a part of the press cake to above 100° C.,
compressing the part of the press cake to form pellets,
returning and mixing the pellets with the low-hull grain fraction prior to the pressing,
cooling the pellets down to a temperature below 60° C.,
and
pressing the cooled pellets mixed with the low-hull grain fraction once again.

15. The method of claim 14, wherein a weight-averaged average size of the pellets mixed with the low-hull grain fraction is at least 50% and at maximum 300% of at least one of an average particle size of the low-hull grain fraction and an average particle size of the grains of the oil-containing seed.

16. The method of claim 15, wherein the weight-averaged average size of the pellets mixed with the low-hull grain fraction is at maximum 200% of at least one of the average particle size of the low-hull grain fraction and the average grain size of the grains of the oil-containing seed, if at least one of the average particle size of the low-hull grain fraction and the average grain size of the grains of the oil-containing seed is more than 5 mm.

17. The method of claim 15, wherein the average size of the pellets mixed with the low-hull grain fraction is adjusted by means of at least one of rolling with crushing rollers and sieving.

18. The method of claim 14, wherein the press cake is comminuted prior to the step of compressing.

19. The method of claim 14, wherein, in the step of pressing, the cooled pellets mixed with the low-hull grain fraction have a temperature in a range from 20 to 35° C.

20. The method of claim 14, wherein, in the step of pressing, the cooled pellets make up 5 to 30 percent by weight of the press cake.

21. The method of claim 14, wherein, in the step of pressing, a residual oil content of 8 to 22 percent by weight of a dry matter of the press cake is adjusted.

22. The method of claim 14, wherein, in the step of pressing, the cooled pellets and the low-hull grain fraction are pressed without addition of heat or while removing heat.
